(19) United States
(12) Patent Application Publication
(10) Pub. No.: US 2017/0134416 A1
(43) Pub. Date: May 11, 2017

(54) SECURITY TECHNIQUES ON INTER-TERMINAL COMMUNICATIONS WITHIN THE SAME SSID UNDER THE SAME AP USING OPENFLOW

(71) Applicant: Jun Kawakita, Tokyo (JP)

(72) Inventor: Jun Kawakita, Tokyo (JP)

(21) Appl. No.: 14/934,372

(22) Filed: Nov. 6, 2015

(51) Int. Cl. H04L 29/06; H04L 12/721

(52) U.S. Cl. CPC H04L 63/1433; H04L 45/38

(57) ABSTRACT

A security management method includes receiving a security check list from a security monitoring device, the security check list containing security issues found by the security monitoring device on a terminal configured to be communicatively connected within one SSID under one AP device to which an SDN controller is configured to be communicatively connected, the SDN controller being included in a security management system which monitors communications between terminals, and which perform shutoff and separation of communications, the one AP device also being configured to be communicatively connected to networks; preparing a communication flow in which communications by the one terminal on which the security issues are found are conducted in the separated network; transmitting the prepared communication flow to the one AP device; and providing to the one AP device, instructions to move the terminal on which the security issues are found from the normal to the separated network.

### BACKGROUND OF THE INVENTION

Technical Field

The disclosure relates to security techniques on inter-terminal communications within the same Service Set Identifier (SSID) under the same Access Point (AP) using OpenFlow®.

Description of Related Art

Software-Defined Networking (SDN) is a technological concept which defines a network with software. In a related-art network device, hardware components, and software components for controlling the hardware components and defining network functions are configured in a singular device. Moreover, the above-mentioned software components are device vendor-specific. Software-Defined Networking (SDN) is a concept which integrally manages the software from Software-Defined Networking (SDN) controller with a common protocol.

Standardized techniques for realizing Software-Defined Networking (SDN) include OpenFlow®, which includes operation definitions of devices such as switches and routers, and protocols for controlling these devices. JP5408243B, for example, discloses a configuration of a network system which is based on OpenFlow®. The disclosed network system includes an OpenFlow® switch which controls transmission and reception of a packet according to flow entries that are retained in a flow table. Each of the flow entries contains a matching condition showing a communication flow of the packet and an action showing processing on the packet that corresponds to the matching condition. The communication flow of the packet may refer to a sequence of the packet from a source to a destination thereof.

VXLAN, which stands for Virtual eXtensible Local Area Network, is one of overlay network techniques which make it possible to build a plurality of network services on an existing network. In VXLAN (Virtual eXtensible Local Area Network), packets from terminals are tunneled to implement logical network segmentation.

A related-art technique for separating communications between wireless terminals and controlling communications using Software-Defined Networking (SDN)/OpenFlow® and VXLAN (Virtual eXtensible Local Area Network) is disclosed, for example, in a non-patent publication called “Present and Future of Software-Defined Networking (SDN)/OpenFlow® technique provided by Stratosphere” by Stratosphere Inc. (Tokyo, Japan) and Japanese patent application publication JP2014-212507A. The above-described related-art technique separates traffic from a wireless terminal to an upper-level network with one Service Set Identifier (SSID) using Software-Defined Networking (SDN)/OpenFlow® and VXLAN (Virtual eXtensible Local Area Network).

Terminals such as a personal computer (PC), a mobile phone, an Android terminal, smartphone terminals such as iPad, iPhone, etc., a printer, a multi-functional peripheral (MFP), etc., having the same Service Set Identifier (SSID) that are connected to one wireless Access Point (AP) in the normal infrastructure mode are permitted to communicate with one another.

FIG. 1A is a diagram illustrating the propriety of communications from one terminal to another and communications between any one of the terminals and an upper-level network in the normal infrastructure mode according to the related art. With reference to FIG. 1A, the communications from one terminal to another of three terminals A, B, C having the same Service Set Identifier (SSID) are permitted and the communications between any one of the terminals A, B, C and the upper-level network through one wireless Access Point (AP) are also permitted. More specifically, the communications between terminals A and B of the three terminals A, B, C having the same Service Set Identifier (SSID) are permitted (shown as “COMMUNICATIONS PERMITTED”) and the communications between the terminals B and C are permitted (shown as “COMMUNICATIONS PERMITTED”). Moreover, the communications between any one of the terminals A, B, C and the upper-level network through the one wireless Access Point (AP) are also permitted (shown as “COMMUNICATIONS PERMITTED”).

However, with the normal infrastructure mode according to the related art, when one of the terminals within the same Service Set Identifier (SSID) is infected with malware codes such as computer viruses, adware, etc., for example, the infected terminal can easily access another of the terminals within the same network without going through the upper-level network. As an example, a certain Access Point (AP) and a Service Set Identifier (SSID) being penetrated in a terminal in which a static IP is set may cause launching of an attack on another terminal within the same Service Set Identifier (SSID).

To prohibit communications between the terminals connected to the one wireless Access Point (AP), a privacy separator (also called a privacy selector) technique such as that used in a public wireless LAN (local area network) to which an unspecified number of terminals are connected may be used. JP2014-195215A, for example, discloses a privacy separator technique in which relaying of communications between individual terminals which belong to a wireless LAN (local area network) is prohibited by switching from a setting for relaying communications between the individual terminals to a setting for not relaying communications between the individual terminals to maintain security within the wireless LAN (local area network).

FIG. 1B is a diagram illustrating the propriety of communications from one terminal to another and communications between any one of the terminals and an upper-level network in the infrastructure mode using the privacy separator technique according to the related art. With reference to FIG. 1B, the communications between any one of the three terminals A, B, C having the same Service Set Identifier (SSID) and the upper-level network through the wireless Access Point (AP) are permitted. However, the communications between the terminals of the three terminals A, B, C having the same Service Set Identifier (SSID) are prohibited. More specifically, the communications between the terminals A and B of the three terminals A, B, C having the same Service Set Identifier (SSID) are prohibited (shown as “COMMUNICATIONS PROHIBITED”) and the communications between the terminals B and C are also prohibited (shown as “COMMUNICATIONS PROHIBITED”). Thus, the privacy separator technique according to the related art may be an effective technique in a case such that the unspecified large number of terminals are connected, such as the public wireless LAN (local area network).

However, the envisaged use of the privacy separator according to the related art is a function which envisages a personal internet access such as a free wi-fi (wireless fidelity) spot, etc. Here, a network access between neighboring terminals (i.e., the terminals A and B, the terminals B and C in FIG. 1B) within the same Service Set Identifier (SSID) under the same Access Point (AP) is prohibited. As the neighboring terminals cannot communicate with each other, they are not able to conduct file sharing such as that for corporate use.

When an Access Point (AP) device is brought to the setting for not relaying communications between the individual terminals to maintain security within the wireless LAN (local area network), the individual terminals connected to the Access Point (AP) device may not be able to execute communications therebetween via the Access Point (AP) device. The above-described publication JP2014-195215A discloses a related-art technique as a countermeasure for the privacy separator technique. It discloses a multi-function peripheral specifying a cause of prohibition of communications between terminals via an Access Point (AP) to cause a message corresponding to the cause to be displayed on a display. However, even though the above-described related-art technique may allow a user to release the terminals from being prohibited from the communications therebetween, the user cannot specify which communications to be prohibited and which communications to be permitted.

### SUMMARY

According to some embodiments of the present invention, a security management method may be provided. The security management method includes receiving, by an SDN controller, a security check list from a security monitoring device configured to be communicatively connected to the SDN controller. The security check list contains a list of one or more security issues found by the security monitoring device on one of a plurality of terminals configured to be communicatively connected within one SSID under one AP device of at least one AP device to which the SDN controller is configured to be communicatively connected. The SDN controller is included in a security management system which monitors communications between the plurality of terminals, and which perform shutoff and separation of communications. The one SSID is one of a plurality of SSIDs. The security management system has the one AP device including a radio module provided with the plurality of SSIDs and configured to be communicatively connected to the plurality of terminals. The communications includes file sharing permitted between the plurality of terminals. The one AP device also is configured to be communicatively connected to a plurality of networks including a normal network and a separated network; preparing, by the SDN controller, a communication flow in which communications by the one terminal on which the one or more security issues are found are conducted in the separated network; transmitting, by the SDN controller, the prepared communication flow to the one AP device; and providing, by the SDN controller to the one AP device, instructions to move the one terminal on which the one or more security issues are found from the normal network to the separated network.

Other aspects of the invention will be apparent from the following description and the appended claims.

### BRIEF DESCRIPTION OF THE DRAWINGS

The embodiments are illustrated by way of example, and not by limitation, in the figures of the accompanying drawings and in which like reference numerals refer to similar elements.

FIG. 1A is a diagram illustrating the propriety of communications from one terminal to another and communications between any one of the terminals and an upper-level network in the normal infrastructure mode according to the related art;

FIG. 1B is a diagram illustrating the propriety of communications from one terminal to another and communications between any one of the terminals and an upper-level network in the infrastructure mode using the privacy separator technique according to the related art;

FIG. 2 is a diagram illustrating the propriety of communications from one terminal to another and communications between any one of the terminals and the upper-level networks in the infrastructure mode using the security management system according to some embodiments of the present invention, which is Secure Flow AP;

FIG. 3 is a block diagram illustrating an exemplary architecture of the security management system according to some embodiments of the present invention, which is Secure Flow AP;

FIG. 4 is a flowchart illustrating an exemplary communications permission sequence for communications from Terminal A to B according to some embodiments of the present invention;

FIG. 5 is a diagram illustrating a use case for the security management system according to some embodiments of the present invention, which is Secure Flow AP, in which a terminal for which security issues are found is separated;

FIG. 6 is a flowchart illustrating a communications prohibition sequence from Terminal C to B according to some embodiments of the present invention;

FIG. 7 is a diagram illustrating various applications and control tables according to some embodiments of the present invention;

FIG. 8 is a diagram illustrating the configuration of a connection-permitted terminal address table according to some embodiments of the present invention; and

FIG. 9 is a diagram illustrating details of a flow table in the security management system according to some embodiments of the present invention, which is Secure Flow AP.

### DETAILED DESCRIPTION

Reference will now be made in detail to various embodiments, examples of which are illustrated in the accompanying drawings. While the claimed embodiments will be described in conjunction with various embodiments, it will be understood that these various embodiments are not intended to limit the scope of the embodiments. On the contrary, the claimed embodiments are intended to cover alternatives, modifications, and equivalents, which may be included within the scope of the appended claims. Furthermore, in the following detailed description of various embodiments, numerous specific details are set forth in order to provide a thorough understanding of the claimed embodiments. However, it will be evident to one of ordinary skill in the art that the claimed embodiments may be practiced without these specific details. In other instances, well known methods, procedures, components, and circuits have not been described in detail as not to unnecessarily obscure aspects of the claimed embodiments.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “transmitting,” “storing,” “determining,” “sending,” “querying,” “providing,” “accessing,” “configuring,” “initiating,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices. For our purposes the term “device” may include hardware components and software components.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may include computer-readable storage media and communication media. Generally, program modules include routines, programs, objects, components, data structures, etc., that perform particular tasks or implement particular abstract data types. The functionality of the program modules may be combined or distributed as desired in various embodiments.

Computer-readable storage media can include volatile and non-volatile, removable and non-removable media implemented in any method or technology for storage of information such as computer-readable instructions, data structures, program modules, or other data. Computer-readable storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

By way of example and not limitation, communication media can include wired media such as a wired network or direct-wired connection, and wireless media such as acoustic, radio frequency (RF), infrared and other wireless media. Combinations of any of the above can also be included within the scope of computer-readable storage media.

In light of the foregoing, some embodiments of the present invention are to add the degree of freedom such that communications between terminals are permitted in a privacy separator which separates one terminal from another with one Service Set Identifier (SSID) and to also make it possible to freely change the communications propriety with an upper-level network. Some embodiments of the present invention achieve the above by providing security management systems and methods which monitor communications between a plurality of terminals which are connected within the same Service Set Identifier (SSID) under the same Access Point (AP) using OpenFlow® techniques including an use of a wireless Access Point (AP) flow table and which perform shutoff and separation of communications.

In the above-described security management method according to some embodiments of the present invention, the instructions to move the one terminal on which the one or more security issues are found from the normal network to the separated network may include an instruction to change an entry representing the one or more security issues on the one terminal in a connection-permitted terminal address table for the one terminal on which the one or more security issues are found.

The above-described security management method according to some embodiments of the present invention may further include determining, by the SDN controller, whether a permission of communications to the one terminal of the plurality of terminals within the one SSID of the plurality of SSIDs under the one AP device is specified, in case the one AP device is in a privacy separator mode in which the communications to the one terminal of the plurality of terminals within the one SSID of the plurality of SSIDs under the one AP device are prohibited; and permitting, by the SDN controller, the communications to the determined one terminal if the permission of the communications to the one terminal is determined to be specified.

In the above-described security management method according to some embodiments of the present invention, permitting, by the SDN controller, the communications to the determined one terminal may include releasing, by the SDN controller, the AP device from the privacy separator mode.

In the above-described security management method according to some embodiments of the present invention, permitting, by the SDN controller, the communications to the determined one terminal may include connecting, by the SDN controller, the one terminal to an SSID which is different from the one SSID of the plurality of SSIDs.

In the above-described security management method according to some embodiments of the present invention, the security management system may further include the plurality of terminals.

In the above-described security management method according to some embodiments of the present invention, the security management system may further include the plurality of networks.

In the above-described security management method according to some embodiments of the present invention, the security management system may further include the security monitoring device.

In the above-described security management method according to some embodiments of the present invention, the security monitoring device may be a vulnerabilities monitoring device, the security issue list may be a vulnerabilities list, and the list of the one or more security issues may be a list of one or more vulnerabilities.

According to some embodiments of the present invention, a non-transitory computer-readable storage medium having stored thereon a computer program product including instructions to cause a computer to perform a security management method is provided, the security management method including receiving, by an SDN controller, a security check list from a security monitoring device configured to be communicatively connected to the SDN controller, the security check list containing a list of one or more security issues found by the security monitoring device on one of a plurality of terminals configured to be communicatively connected within one SSID under one AP device of at least one AP device to which the SDN controller is configured to be communicatively connected, the SDN controller being included in a security management system which monitors communications between the plurality of terminals, and which perform shutoff and separation of communications, the one SSID being one of a plurality of SSIDs, the security management system having the one AP device including a radio module provided with the plurality of SSIDs and configured to be communicatively connected to the plurality of terminals, the communications including file sharing permitted between the plurality of terminals, the one AP device also being configured to be communicatively connected to a plurality of networks including a normal network and a separated network; preparing, by the SDN controller, a communication flow in which communications by the one terminal on which the one or more security issues are found are conducted in the separated network; transmitting, by the SDN controller, the prepared communication flow to the one AP device; and providing, by the SDN controller to the one AP device, instructions to move the one terminal on which the one or more security issues are found from the normal network to the separated network.

In the above-described non-transitory computer-readable storage medium according to some embodiments of the present invention, the instructions to move the one terminal on which the one or more security issues are found from the normal network to the separated network may include an instruction to change an entry representing the one or more security issues on the one terminal in a connection-permitted terminal address table for the one terminal on which the one or more security issues are found.

In the above-described non-transitory computer-readable storage medium according to some embodiments of the present invention, the security management method may further include determining, by the SDN controller, whether a permission of communications to the one terminal of the plurality of terminals within the one SSID of the plurality of SSIDs under the one AP device is specified, in case the one AP device is in a privacy separator mode in which the communications to the one terminal of the plurality of terminals within the one SSID of the plurality of SSIDs under the one AP device are prohibited; and permitting, by the SDN controller, the communications to the determined one terminal if the permission of the communications to the one terminal is determined to be specified.

In the above-described non-transitory computer-readable storage medium according to some embodiments of the present invention, permitting, by the SDN controller, the communications to the determined one terminal may include releasing, by the SDN controller, the AP device from the privacy separator mode.

In the above-described non-transitory computer-readable storage medium according to some embodiments of the present invention, permitting, by the SDN controller, the communications to the determined one terminal may include connecting, by the SDN controller, the one terminal to an SSID which is different from the one SSID of the plurality of SSIDs.

In the above-described non-transitory computer-readable storage medium according to some embodiments of the present invention, the security management system may further include the plurality of terminals.

In the above-described non-transitory computer-readable storage medium according to some embodiments of the present invention, the security management system may further include the plurality of networks.

In the above-described non-transitory computer-readable storage medium according to some embodiments of the present invention, the security management system may further include the security monitoring device.

In the above-described non-transitory computer-readable storage medium according to some embodiments of the present invention, the security monitoring device may be a vulnerabilities monitoring device, the security issue list may be a vulnerabilities list, and the list of the one or more security issues may be a list of one or more vulnerabilities.

According to some embodiments of the present invention, a security management system is provided, the security management system including at least one AP device, under which one AP device of the at least one AP device a plurality of terminals being configured to be communicatively connected within one SSID, the security management system to monitor communications between the plurality of terminals and to perform shutoff and separation of communications, the one SSID being one of a plurality of SSIDs, the one AP device including a radio module provided with the plurality of SSIDs and configured to be communicatively connected to the plurality of terminals, the communications including file sharing permitted between the plurality of terminals, the one AP device also being configured to be communicatively connected to the plurality of networks including a normal network and a separated network; and an SDN controller which is configured to be communicatively connected to the one AP device and which is further configured to receive a security issue list from a security monitoring device which is communicatively connected to the SDN controller, the security issue list containing a list of one or more security issues on one of the plurality of terminals that are found by the security monitoring device; prepare a communication flow in which communications by the one terminal on which the one or more security issues are found are conducted in the separated network; transmit the prepared communication flow to the AP device; and provide, to the AP device, instructions to move the one terminal on which the one or more security issues are found from the normal network to the separated network.

In the above-described security management system according to some embodiments of the present invention, the instructions to move the one terminal on which the one or more security issues are found from the normal network to the separated network may include an instruction to change an entry representing the one or more security issues on the one terminal in a connection-permitted terminal address table for the one terminal on which one or more security issues are found.

In the above-described security management system according to some embodiments of the present invention, the SDN controller may further be configured to determine whether a permission of communications to the one terminal of the plurality of terminals within the one SSID of the plurality of SSIDs under the one AP device is specified, in case the one AP device is in a privacy separator mode in which the communications to the one terminal of the plurality of terminals within the one SSID of the plurality of SSIDs under the one AP device are prohibited; and permit the communications to the determined one terminal if the permission of the communications to the one terminal is determined to be specified.

In the above-described security management system according to some embodiments of the present invention, the SDN controller may further be configured to release the AP device from the privacy separator mode.

In the above-described security management system according to some embodiments of the present invention, the SDN controller may further be configured to connect the one terminal to an SSID which is different from the one SSID of the SSIDs.

The above-described security management system according to some embodiments of the present invention may further include the plurality of terminals.

The above-described security management system according to some embodiments of the present invention may further include the plurality of networks.

The above-described security management system according to some embodiments of the present invention may further include the security monitoring device.

In the above-described security management system according to some embodiments of the present invention, the security monitoring device may be a vulnerabilities monitoring device, the security issue list is a vulnerabilities list, and the list of the one or more security issues is a list of one or more vulnerabilities.

Embodiments of the present invention make use of a related-art privacy separator function utilized in wireless LAN (local area network) services. While the related-art privacy separator function prohibits communications between the same access point (AP) within the same Service Set Identifier (SSID), embodiments of the present invention make it possible to select communications to be prohibited and communications to be permitted, not prohibiting all inter-terminal communications. Thus, embodiments of the present invention make it possible to permit a use of a neighboring access point (AP) for corporate use.

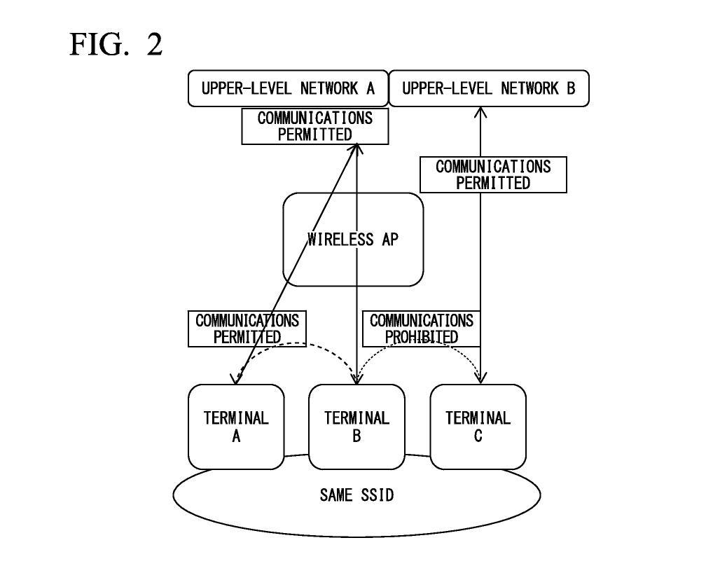

FIG. 2 is a diagram illustrating the propriety of communications from one terminal to another and communications between any one of the terminals and the upper-level networks in the infrastructure mode using the security management system according to some embodiments of the present invention, which is Secure Flow AP. The security management system according to some embodiments of the present invention makes it possible to select a terminal to/from which communications are permitted and a terminal to/from which communications are prohibited. With reference to FIG. 2, when the terminal C is set as a terminal to/from which communications are prohibited, communications between the terminals A and B are permitted and communications from the terminals A and B to an upper-level network A are permitted, while communications between the terminals B and C are prohibited.

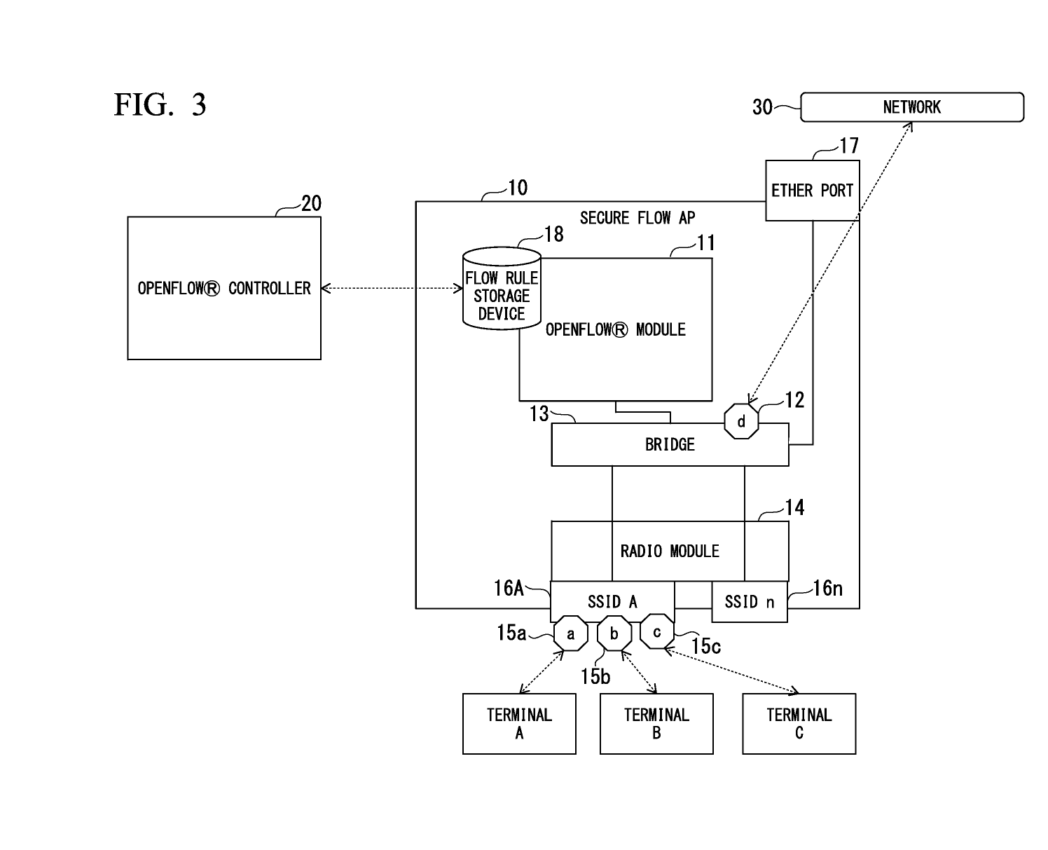

FIG. 3 is a block diagram illustrating an exemplary architecture of the security management system according to some embodiments of the present invention, which is Secure Flow AP;

With reference to FIG. 3, the security management system 10 according to some embodiments of the present invention, which is Secure Flow AP, is provided with an OpenFlow® module 11; a port (shown as “d”) 12; a bridge 13, which is configured to be connected to the OpenFlow® module 11 and which is also configured to be connected to a Network 30 via the port (“d”) 12; a radio module 14; ports (shown as “a”, “b”, “c”) 15a, 15b, and 15c that are respectively configured to be connected to terminals A, B, and C; an Service Set Identifier (SSID) A, or 16A, and an Service Set Identifier (SSID) n, or 16n, which are respectively provided on the radio module 14; an Ether port 17 which is configured to be connected to the bridge 13; and a flow rule storage device 18, which is configured to be connected to an OpenFlow® controller 20 (a Software-Defined Networking (SDN) controller). Here, the terminals A, B, C may include a server computer, a workstation computer, a desktop computer, a laptop computer, a thin-client, and other forms of personal computer (PCs), an Android terminal, a printer, a multi-functional peripheral (MFP), mobile devices including cellphones, smartphone terminals such as iPad, iPhone, etc., while they are not limited thereto.

Below, two general use cases for the security management system according to some embodiments of the present invention, which is Secure Flow AP, are described.

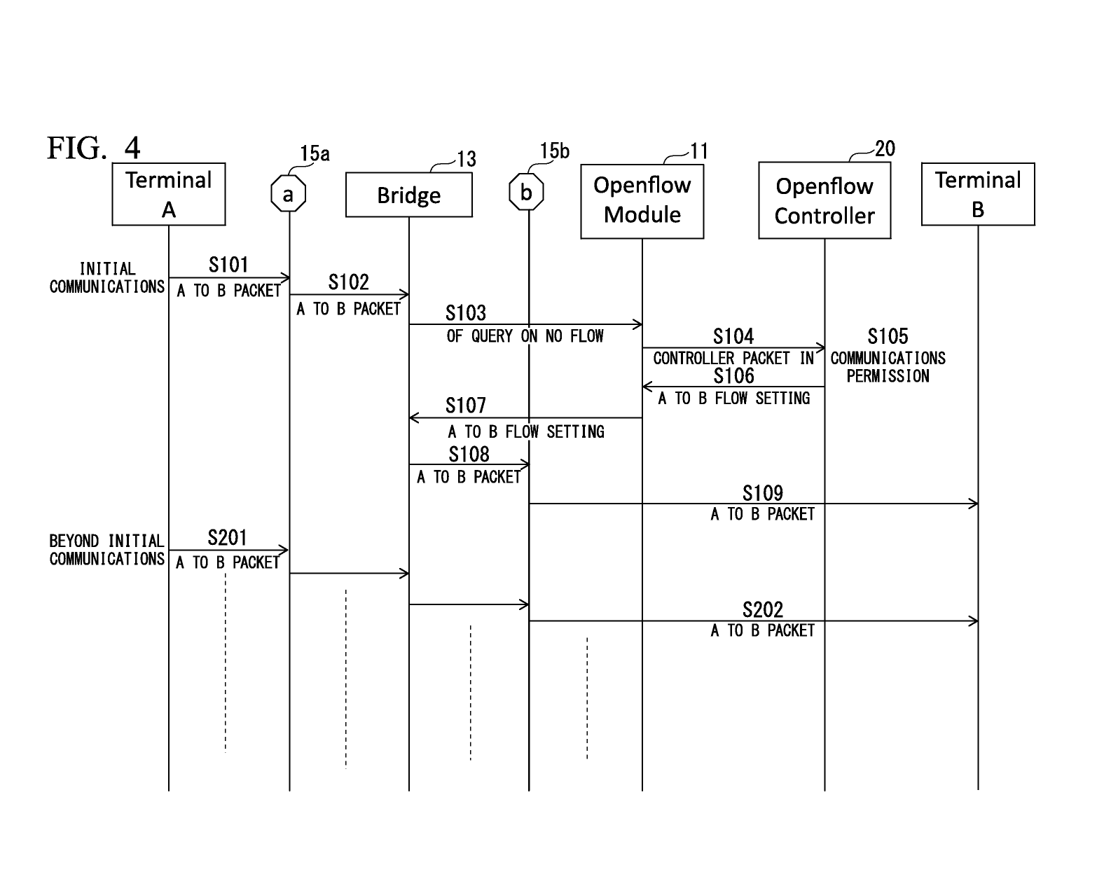

First, with reference to FIG. 4, a first general use case which is concerned with communications shutoff and separation of a terminal permitted to conduct network communications is described. In conjunction thereto, a permission sequence for communications from one terminal to another is exemplified below. FIG. 4 is a diagram illustrating an exemplary communications permission sequence for communications from terminal A to B in normal communications.

The upper portion in FIG. 4 shows an exemplary communications permission sequence for initial communications. In Step S101 (shown as “A TO B PACKET”), an A to B packet is sent from the terminal A to the port a 15a. In Step S102 (shown as “A TO B PACKET”), the received A to B packet is sent to the bridge 13. In Step S103 (shown as “OF QUERY ON NO FLOW”), upon receiving the A to B packet, the bridge 13 makes an OF query on No Flow to the OpenFlow® module 11. In Step S104 (shown as “CONTROLLER PACKET IN”), upon receiving the OF query on No Flow from the bridge 13, the OpenFlow® module 11 sends a Controller Packet In message to the OpenFlow® controller 20 (Software-Defined Networking (SDN) controller). In Step S105 (shown as “COMMUNICATIONS PERMISSION”), upon receiving the Controller Packet In message from the OpenFlow® module 11, the OpenFlow® controller 20 (Software-Defined Networking (SDN) controller) permits communications from terminal A to B. In Step S106 (shown as “A TO B FLOW SETTING”), the OpenFlow® controller 20 (Software-Defined Networking (SDN) controller) sends an A to B Flow setting message to the OpenFlow® module 11. In Step S107 (shown as “A TO B FLOW SETTING”), the received A to B Flow setting message is sent by the OpenFlow® module 11 to the bridge 13. In Step S108 (shown as “A TO B PACKET”), the bridge 13 sends the A to B packet to the port b 15b. In Step S109 (shown as “A TO B PACKET”), the received A to B packet is sent to the terminal B, so that the communications from terminal A to B are successfully initiated. The lower portion in FIG. 4 shows an exemplary communications permission sequence for communications beyond the initial communications. In Step S201 (shown as “A TO B PACKET”), the terminal A sends an A to B packet to the port a 15a. The sequence then proceeds such that it eventually ends with the A to B packet being sent to the terminal B in Step S202 (shown as “A TO B PACKET”).

When, after communications are started with a terminal to which network communications are permitted, such as in the normal communications as shown in FIG. 4, the terminal is determined to be problematic from a security point of view, the determined terminal may be subjected to communications shutoff and separation.

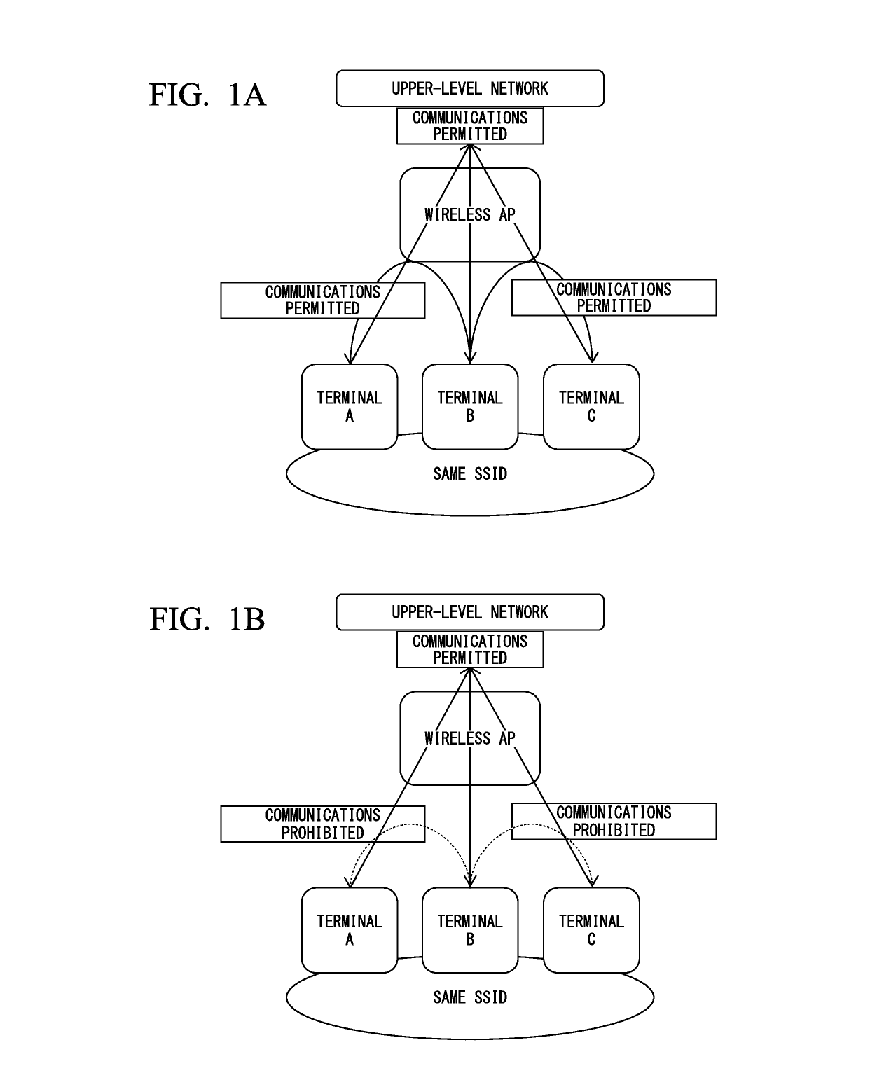

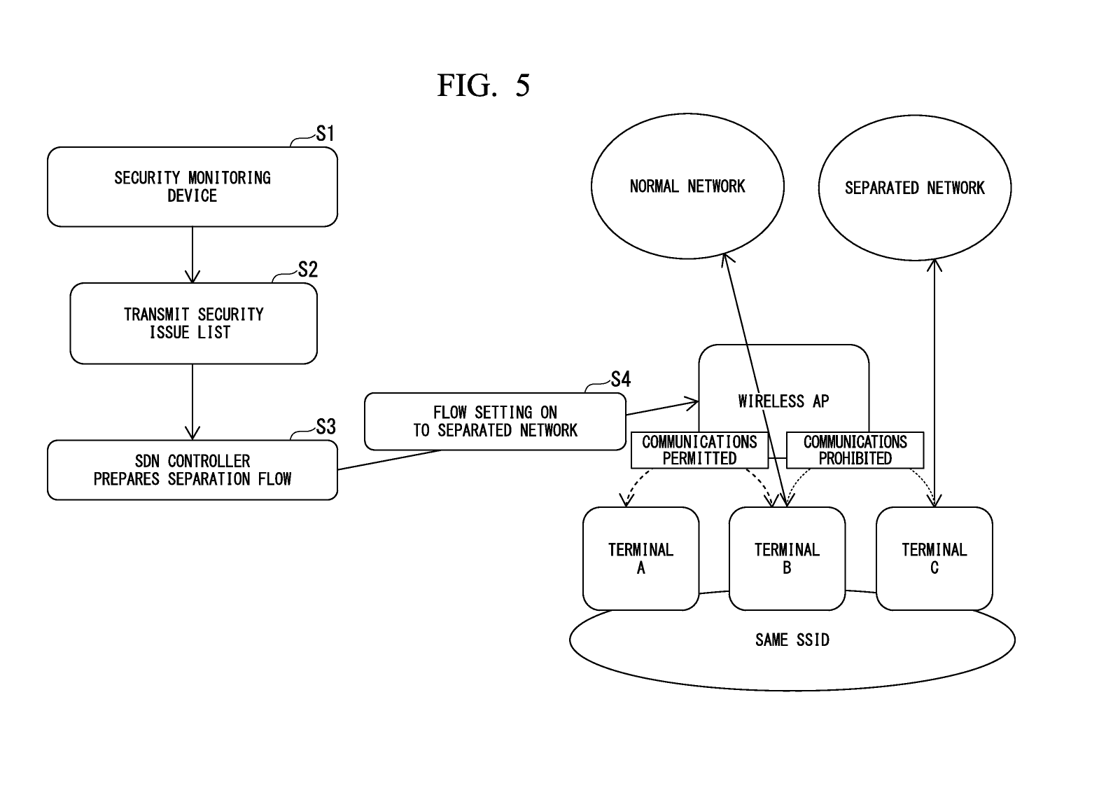

The first general use case, which is concerned with communications shutoff and separation of a terminal permitted to conduct network communications, may be further exemplified in a specific use case in which a terminal with security issues is separated with reference to FIGS. 1A and 5.

Here, as shown in FIG. 1A, terminals A, B, and C are within the same Service Set Identifier (SSID) under the same access point (AP) and are permitted to conduct communications such as file sharing, etc., therebetween.

FIG. 5 is a diagram illustrating the specific use case for the security management system according to some embodiments of the present invention, which is Secure Flow AP, in which a terminal for which security issues are found is separated.

Actions of the security management system according to some embodiments of the present invention, which is Secure Flow AP, when the security issues such as vulnerabilities, viruses, behavior, IT asset management issues are found on the terminal C are shown as follows:
(1) A securities monitoring device finds security issues on the terminal C (shown as “S1: SECURITY MONITORING DEVICE”);
(2) A security issue list is transmitted to the Software-Defined Networking (SDN) controller (shown as “S2: TRANSMIT SECURITY ISSUE LIST”);
(3) The Software-Defined Networking (SDN) controller prepares a flow for conducting communications by the terminal C in a separated network (shown as “S3: SDN CONTROLLER PREPARES SEPARATION FLOW”) and transmits the prepared flow to the wireless access point (AP) (shown as “S4: FLOW SETTING ON TO SEPARATED NETWORK”); and
(4) The terminal C is instructed to move from a normal network (shown as “NORMAL NETWORK”) to a separated network (shown as “SEPARATED NETWORK”).

The security monitoring devices include devices which monitor and detect security issues such as vulnerabilities including malware infections, viruses, unauthorized behaviors in the networking environment, IT asset management issues, etc., and realize automatic separation and monitoring of terminals, and automatic blocking of the access to malicious websites in cooperation with a Software-Defined Networking (SDN) controller.

The security monitoring devices include applications to find vulnerabilities in the corporate IT environment.

Commercially-available applications to find vulnerabilities in the corporate IT environment, such as so-called “security holes” etc., include, for example, ISM CloudOne from QualitySoft Corporation (Tokyo, Japan). In the ISM CloudOne, the ISM CloudOne agent reports the ISM CloudOne server of information on vulnerability checking (so-called “inventory information”) through a batch process (a night-time batch process, etc.). The ISM CloudOne server checks vulnerabilities, collects information on the individual terminals, and reports results on the information collection, such as a MAC address of terminals, timing on vulnerability checking, determination on “OK” (meaning Good)/“NG” (meaning No Good) of the terminals, etc., via an API to a Software-Defined Networking (SDN) controller, which instructs an OpenFlow®-compliant network device to move a terminal determined to be “NG” (meaning No Good) to a quarantine network, which is separate from a normal network.

However, the above-described applications to find vulnerabilities in the corporate IT environment are not sufficient to find vulnerabilities in the networking environment, such as advanced persistent threats (APT) and the latest generation of malware. There are commercially-available applications to find such vulnerabilities in the networking environment. They include, for example, Deep Discovery Inspector (DDI) from Trend Micro Inc. (Tokyo, Japan). The Deep Discovery Inspector (DDI) detects a possibly-threated terminal by checking communications in front of a proxy server, in front of important servers, and at the gate of a department network to be protected, and reports on the possibly-threated terminal detected (e.g., a MAC address, an IP address of the possibly-threated terminals, the level and nature of threats, etc.) via an API to a Software-Defined Networking (SDN) controller, which instructs an OpenFlow®-compliant network device to move the possibly-threated terminal to a separated network.

The security management system according to some embodiments of the present invention, which is Secure Flow AP, in the present use case may establish communications in a separated network and facilitate cooperation with security engines. In the related-art solutions for the above-described separation function, a different Service Set Identifier (SSID) needs to be assigned to a terminal to be separated and MAC authentication thereto needs to be set. Moreover, the terminal to be separated needs to manually set separately a process of connection to the different Service Set Identifier (SSID).

As described above, some embodiments of the present invention make it possible to specify communications to be prohibited within all inter-terminal communications, thus not prohibiting all inter-terminal communications. Therefore, some embodiments of the present invention make it possible to permit a use of a neighboring access point (AP) for corporate use in communications such as file sharing, etc.

Moreover, some embodiments of the present invention make it possible to perform, when security issues are found on a certain terminal, an action of shutting off communications from the terminal.

Furthermore, some embodiments of the present invention make it possible to perform the above-mentioned action at any time, thus permitting communications as usual in circumstances such as at the initial stage of starting communications, at the time of booting a terminal, etc., and, thereafter, making it possible to perform, after connecting to an access point (AP), shutting off of communications with the access point (AP) upon reporting of security issues.

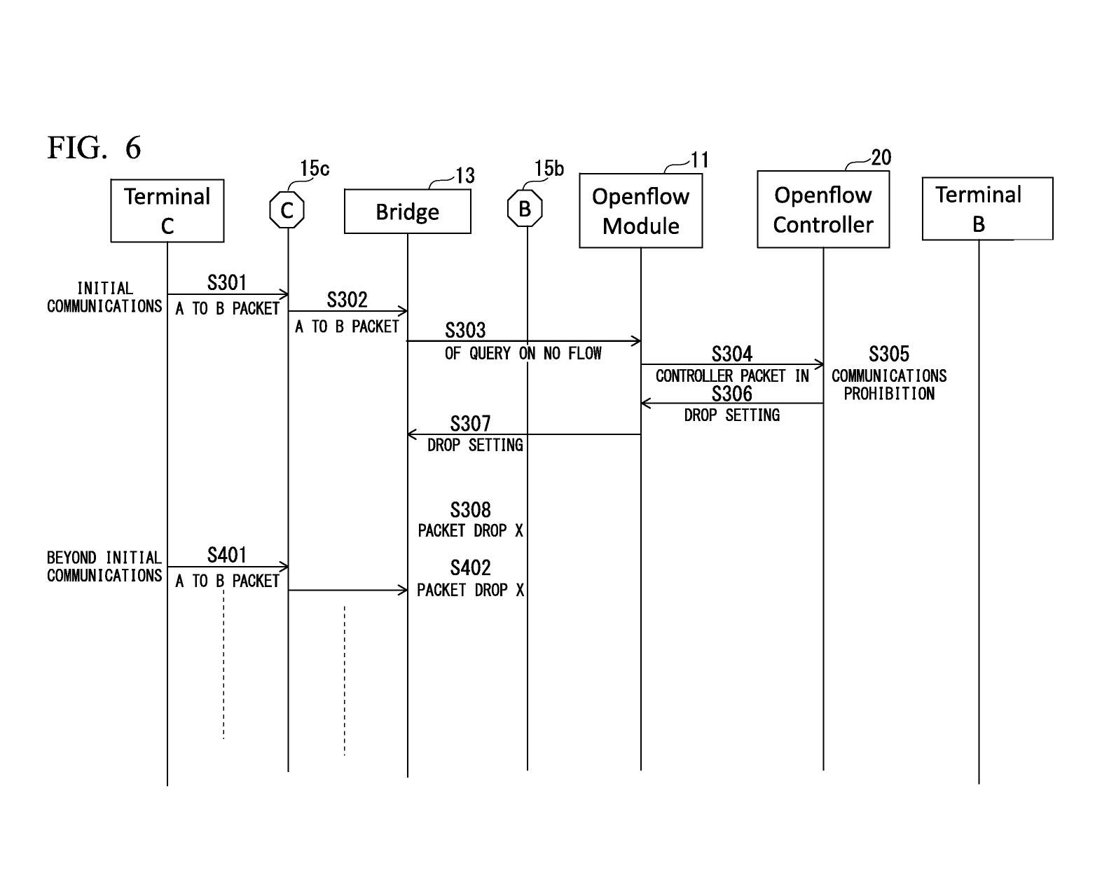

Next, with reference to FIG. 6, a second general use case which is concerned with a function of grouping from the terminal communications separation state within the same Service Set Identifier (SSID), such as a privacy separator is described. In this second general use case, the security management system according to some embodiments of the present invention, which is Secure Flow AP, is used in the privacy separator mode and inter-terminal communications are prohibited for strengthening security. In conjunction thereto a communications prohibition sequence from one terminal to another is exemplified below. FIG. 6 is a diagram illustrating a communications prohibition sequence from the terminal C to B.

The upper portion in FIG. 6 shows an exemplary communications prohibition sequence for initial communications. In Step S301 (shown as “A TO B PACKET”), the terminal C sends an A to B packet to the port c 15c. In Step S302 (shown as “A TO B PACKET”), the received A to B packet is sent to the bridge 13. In Step S303 (shown as “OF QUERY ON NO FLOW”), upon receiving the A to B packet, the bridge 13 makes an OF query on No Flow to the OpenFlow® module 11. In Step S304 (shown as “CONTROLLER PACKET IN”), upon receiving the OF query on No Flow, the OpenFlow® module 11 sends a Controller Packet In message to the OpenFlow® controller 20 (Software-Defined Networking (SDN) controller). In Step S305 (shown as “COMMUNICATIONS PROHIBITION”), upon receiving the Controller Packet In message, the OpenFlow® controller 20 (Software-Defined Networking (SDN) controller) prohibits communications to the terminal B. In Step S306 (shown as “DROP SETTING”), the OpenFlow® controller 20 (Software-Defined Networking (SDN) controller) sends a Drop setting message to the OpenFlow® module 11. In Step S307 (shown as “DROP SETTING”), the OpenFlow® module 11 sends the received Drop setting message to the bridge 13. The sequence then proceeds such that it eventually ends with the bridge 13 conducting a Packet Drop X in Step S308 (shown as “PACKET DROP X”). The lower portion in FIG. 6 shows an exemplary communications prohibition sequence for communications beyond the initial communications. In Step S401 (shown as “A TO B PACKET”), the terminal A sends an A to B packet to the bridge 13. The sequence then proceeds such that it eventually ends with the bridge 13 conducting a Packet Drop X in Step S402 (shown as “PACKET DROP X”).

This second use case according to some embodiments of the present invention may permit communications within the Service Set Identifier (SSID) by specifying a terminal using file sharing, etc., while the security management system according to some embodiments of the present invention, which is Secure Flow AP, is used in the privacy separator mode and inter-terminal communications are prohibited for strengthening security.

The present second generic use case in some embodiments of the present invention provides the security management system according to some embodiments of the present invention, which is Secure Flow AP, which includes settings for permitting communications within the same Service Set Identifier (SSID), such as releasing the privacy separator mode on the access point (AP) side, or connecting the terminal to a different Service Set Identifier (SSID) (permitting terminal communications).

Hereinbelow, specific mechanisms to select communications to be prohibited and communications to be permitted in the security management system according to some embodiments of the present invention, which is Secure Flow AP, are described.

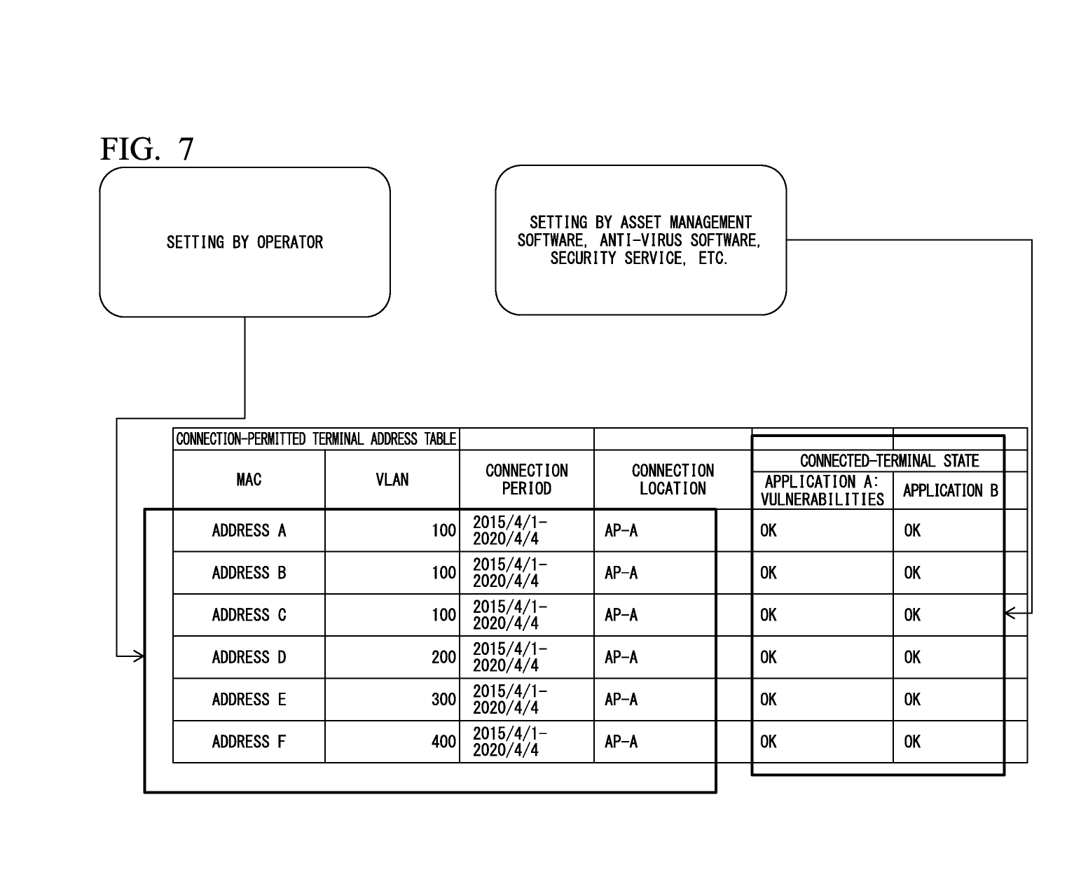

FIG. 7 is a diagram illustrating a connection-permitted terminal address table according to some embodiments of the present invention.

The connection-permitted terminal address table includes one set of fields shown as “MAC”, “VLAN”, “CONNECTION PERIOD”, and “CONNECTION LOCATION” that is set by the operator via CSV, GUI, etc., and another set of fields shown as “APPLICATION A: VULNERABILITIES” and “APPLICATION B” (also collectively shown as “CONNECTED-TERMINAL STATE”) that is set by asset management software, security services, anti-virus software, etc. via API, Log.

Commercially available asset management software products and security services providers include ISM CloudOne and QualitySoft, which have been described earlier. Commercially available anti-virus software products include “Kaspersky Anti-Virus” from Kaspersky Lab (Paddington, United Kingdom).

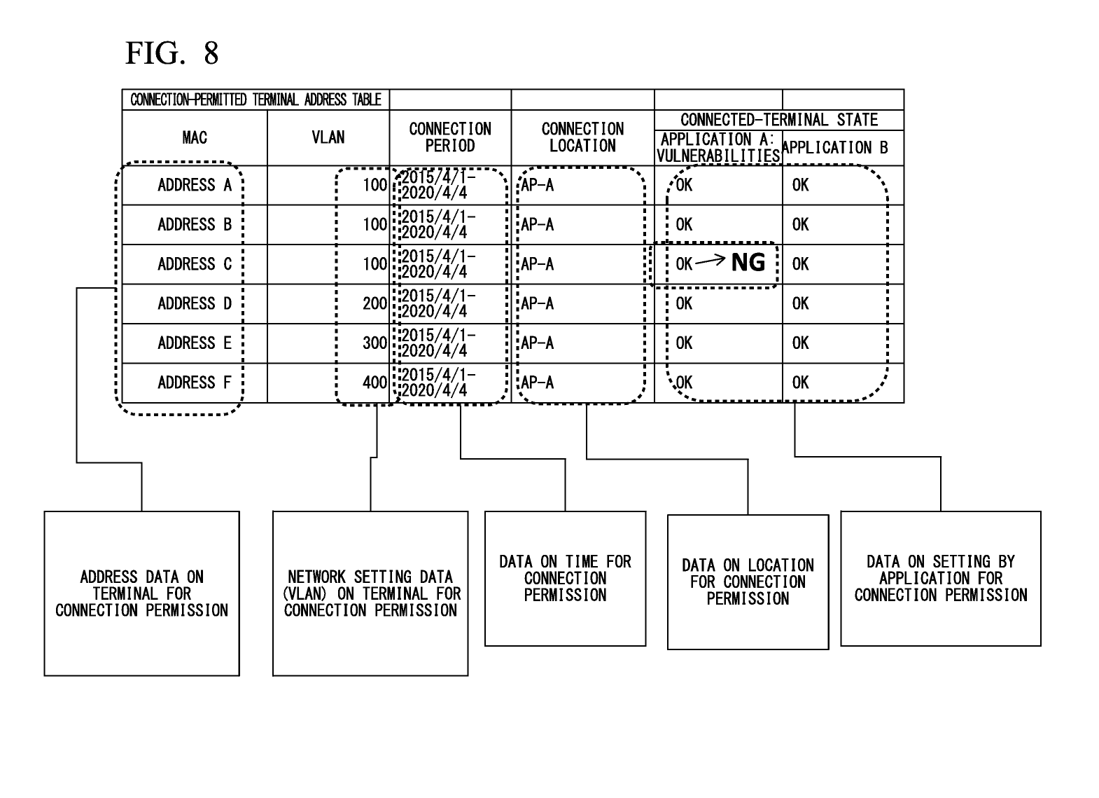

FIG. 8 is a diagram illustrating details of the connection-permitted terminal address table according to some embodiments of the present invention.

The entries shown as “ADDRESS A”, “ADDRESS B”, “ADDRESS C”, “ADDRESS D”, “ADDRESS E”, and “ADDRESS F” in the MAC field represent address data on terminals for connection permission. The entries shown in the VLAN field represent network setting data on terminals for connection permission. The entries shown in the connection period field represent data on time for connection. The entries shown in the connection location field represent data on location for connection permission. The entries shown in the connected-terminal state fields including the application A: vulnerabilities field and the application B field represent data on setting by application for connection permission.

When communications to be prohibited are to be selected in the above-described first generic and specific use cases according to some embodiments of the present invention, the portion of the entries shown in the application A: vulnerabilities field is changed from A to B.

As described above, some embodiments of the present invention make it possible to specify communications to be prohibited within all inter-terminal communications, thus not prohibiting all inter-terminal communications. Therefore, some embodiments of the present invention make it possible to permit a use of a neighboring access point (AP) for corporate use in communications such as file sharing, etc.

Moreover, some embodiments of the present invention make it possible to perform, when security issues such as vulnerabilities are found in a certain terminal, an action of shutting off communications from the terminal.

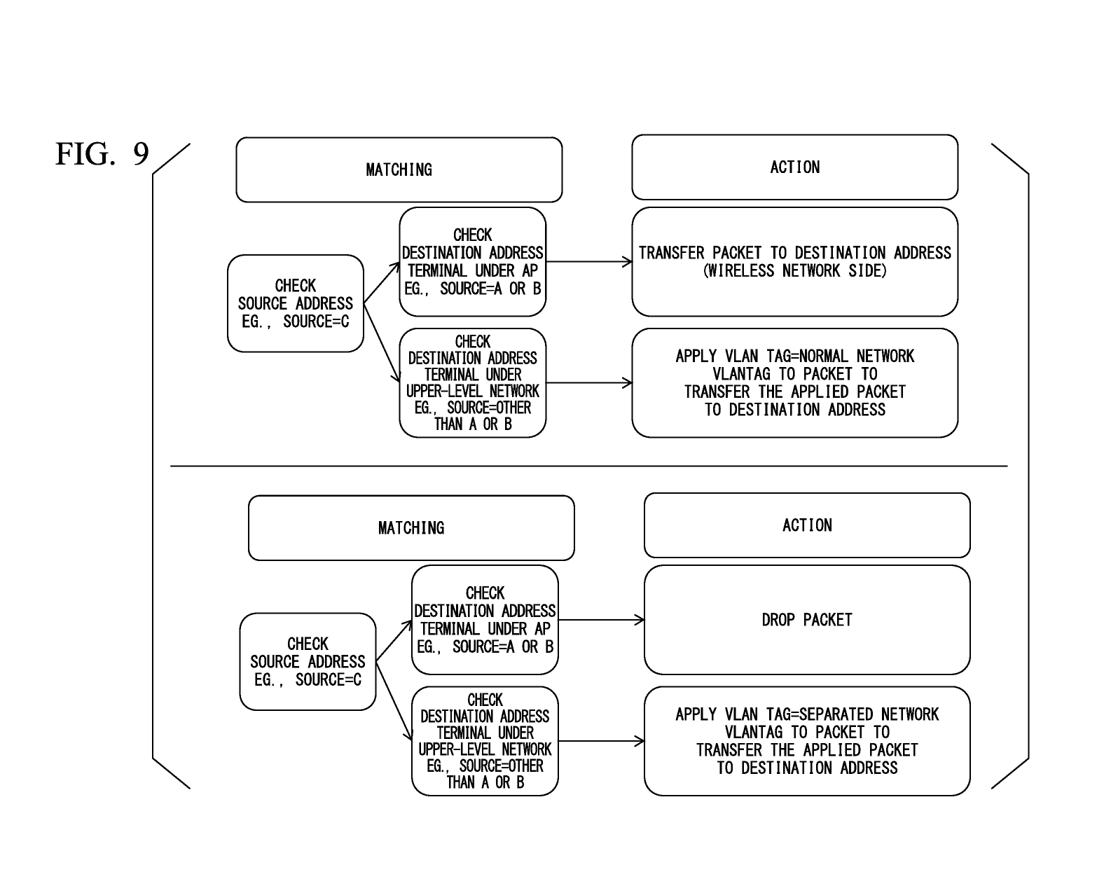

FIG. 9 is a diagram illustrating details of a flow table in Secure Flow AP according to some embodiments of the present invention. The flow table (also called a flow matching table) in Secure Flow AP according to some embodiments of the present invention retains a plurality of flow entries, each of which flow entries being provided with two elementary fields called a matching field and an action field. The matching field contains a matching condition which represents a conditional equation to be compared with upon receipt of a packet, while an action field contains an action which represents a process to be executed on the received packet when the corresponding matching condition in the matching field is matched.

The upper half of FIG. 9 represents one set of matching conditions (shown as “MATCHING”) and actions (shown as “ACTION”) corresponding to the one set of matching conditions for a normal case of communications from terminal C.

If the matching condition that the result of “source address Check” being source=C, for example, is matched, the action being the process of transferring a packet to the destination address is executed (on the wireless network side) when the matching condition that the result of “destination address Check: terminal under AP” being source=a or b, for example is matched, while the action being the process of transferring a packet having applied a VLANtag=normal network VLANtag to the destination address is executed when the matching condition that the result of “destination address Check: upper-level network terminal” being source=other than a or b, for example, is matched.

The lower half of FIG. 9 represents another set of matching conditions (shown as “MATCHING”) and actions (shown as “ACTION”) corresponding to the other set of matching conditions for a case of communications from terminal C after separation.

If the matching condition that the result of “source address Check” being source=C, for example, is matched, the action being the process of dropping a packet is executed, which means that the packet is not transferred, when the matching condition that the result of “destination address Check: terminal under AP” being source=a or b, for example is matched, while the action being the process of transferring a packet having applied a VLANtag=separated network VLANtag to the destination address is executed when the matching condition that the result of “destination address Check: upper-level network terminal” being source=other than a or b, for example, is matched.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A security management method, comprising:
receiving, by an SDN controller, a security check list from a security monitoring device configured to be communicatively connected to the SDN controller, the security check list containing a list of one or more security issues found by the security monitoring device on one of a plurality of terminals configured to be communicatively connected within one SSID under one AP device of at least one AP device to which the SDN controller is configured to be communicatively connected, the SDN controller being included in a security management system which monitors communications between the plurality of terminals, and which perform shutoff and separation of communications, the one SSID being one of a plurality of SSIDs, the security management system having the one AP device including a radio module provided with the plurality of SSIDs and configured to be communicatively connected to the plurality of terminals, the communications including file sharing permitted between the plurality of terminals, the one AP device also being configured to be communicatively connected to a plurality of networks including a normal network and a separated network;
preparing, by the SDN controller, a communication flow in which communications by the one terminal on which the one or more security issues are found are conducted in the separated network;
transmitting, by the SDN controller, the prepared communication flow to the one AP device; and
providing, by the SDN controller to the one AP device, instructions to move the one terminal on which the one or more security issues are found from the normal network to the separated network.

2. The security management method as claimed in claim 1,
wherein the instructions to move the one terminal on which the one or more security issues are found from the normal network to the separated network include an instruction to change an entry representing the one or more security issues on the one terminal in a connection-permitted terminal address table for the one terminal on which the one or more security issues are found.

3. The security management method as claimed in claim 1, further comprising, determining, by the SDN controller, whether a permission of communications to the one terminal of the plurality of terminals within the one SSID of the plurality of SSIDs under the one AP device is specified, in case the one AP device is in a privacy separator mode in which the communications to the one terminal of the plurality of terminals within the one SSID of the plurality of SSIDs under the one AP device are prohibited; and
permitting, by the SDN controller, the communications to the determined one terminal if the permission of the communications to the one terminal is determined to be specified.

4. The security management method as claimed in claim 3,
wherein permitting, by the SDN controller, the communications to the determined one terminal includes releasing, by the SDN controller, the AP device from the privacy separator mode.

5. The security management method as claimed in claim 3,
wherein permitting, by the SDN controller, the communications to the determined one terminal includes connecting, by the SDN controller, the one terminal to an SSID which is different from the one SSID of the plurality of SSIDs.

6. The security management method as claimed in claim 1, wherein the security management system further includes the plurality of terminals.

7. The security management method as claimed in claim 6, wherein the security management system further includes the plurality of networks.

8. The security management method as claimed in claim 7, wherein the security management system further includes the security monitoring device.

9. The security management method as claimed in claim 1, wherein the security monitoring device is a vulnerabilities monitoring device, the security issue list is a vulnerabilities list, and the list of the one or more security issues is a list of one or more vulnerabilities.

10. The security management method as claimed in claim 8, wherein the security monitoring device is a vulnerabilities monitoring device, the security issue list is a vulnerabilities list, and the list of the one or more security issues is a list of one or more vulnerabilities.

11. A non-transitory computer-readable storage medium having stored thereon a computer program product including instructions to cause a computer to perform a security management method, the security management method comprising:
receiving, by an SDN controller, a security check list from a security monitoring device configured to be communicatively connected to the SDN controller, the security check list containing a list of one or more security issues found by the security monitoring device on one of a plurality of terminals configured to be communicatively connected within one SSID under one AP device of at least one AP device to which the SDN controller is configured to be communicatively connected, the SDN controller being included in a security management system which monitors communications between the plurality of terminals, and which perform shutoff and separation of communications, the one SSID being one of a plurality of SSIDs, the security management system having the one AP device including a radio module provided with the plurality of SSIDs and configured to be communicatively connected to the plurality of terminals, the communications including file sharing permitted between the plurality of terminals, the one AP device also being configured to be communicatively connected to a plurality of networks including a normal network and a separated network;
preparing, by the SDN controller, a communication flow in which communications by the one terminal on which the one or more security issues are found are conducted in the separated network;
transmitting, by the SDN controller, the prepared communication flow to the one AP device; and
providing, by the SDN controller to the one AP device, instructions to move the one terminal on which the one or more security issues are found from the normal network to the separated network.

12. The non-transitory computer-readable storage medium as claimed in claim 11, wherein the instructions to move the one terminal on which the one or more security issues are found from the normal network to the separated network include an instruction to change an entry representing the one or more security issues on the one terminal in a connection-permitted terminal address table for the one terminal on which the one or more security issues are found.

13. The non-transitory computer-readable storage medium as claimed in claim 11, the security management method further comprising:
determining, by the SDN controller, whether a permission of communications to the one terminal of the plurality of terminals within the one SSID of the plurality of SSIDs under the one AP device is specified, in case the one AP device is in a privacy separator mode in which the communications to the one terminal of the plurality of terminals within the one SSID of the plurality of SSIDs under the one AP device are prohibited; and
permitting, by the SDN controller, the communications to the determined one terminal if the permission of the communications to the one terminal is determined to be specified.

14. The non-transitory computer-readable storage medium as claimed in claim 13, wherein permitting, by the SDN controller, the communications to the determined one terminal includes releasing, by the SDN controller, the AP device from the privacy separator mode.

15. The non-transitory computer-readable storage medium as claimed in claim 13, wherein permitting, by the SDN controller, the communications to the determined one terminal includes connecting, by the SDN controller, the one terminal to an SSID which is different from the one SSID of the plurality of SSIDs.

16. The non-transitory computer-readable storage medium as claimed in claim 11, wherein the securities management system further includes the plurality of terminals.

17. The non-transitory computer-readable storage medium as claimed in claim 16, wherein the securities management system further includes the plurality of networks.

18. The non-transitory computer-readable storage medium as claimed in claim 17, wherein the securities management system further includes the security monitoring device.

19. The non-transitory computer-readable storage medium as claimed in claim 11, wherein the security monitoring device is a vulnerabilities monitoring device, the security issue list is a vulnerabilities list, and the list of the one or more security issues is a list of one or more vulnerabilities.

20. The non-transitory computer-readable storage medium as claimed in claim 18, wherein the security monitoring device is a vulnerabilities monitoring device, the security issue list is a vulnerabilities list, and the list of the one or more security issues is a list of one or more vulnerabilities.

21. A security management system, comprising:
at least one AP device, under which one AP device of the at least one AP device a plurality of terminals being configured to be communicatively connected within one SSID, the security management system to monitor communications between the plurality of terminals and to perform shutoff and separation of communications, the one SSID being one of a plurality of SSIDs, the one AP device including a radio module provided with the plurality of SSIDs and configured to be communicatively connected to the plurality of terminals, the communications including file sharing permitted between the plurality of terminals, the one AP device also being configured to be communicatively connected to the plurality of networks including a normal network and a separated network; and
an SDN controller which is configured to be communicatively connected to the one AP device and which is further configured to receive a security issue list from a security monitoring device which is communicatively connected to the SDN controller, the security issue list containing a list of one or more security issues on one of the plurality of terminals that are found by the security monitoring device;
prepare a communication flow in which communications by the one terminal on which the one or more security issues are found are conducted in the separated network;
transmit the prepared communication flow to the AP device; and
provide, to the AP device, instructions to move the one terminal on which the one or more security issues are found from the normal network to the separated network.

22. The security management system as claimed in claim 21,
wherein the instructions to move the one terminal on which the one or more security issues are found from the normal network to the separated network include an instruction to change an entry representing the one or more security issues on the one terminal in a connection-permitted terminal address table for the one terminal on which one or more security issues are found.

23. The security management system as claimed in claim 21, wherein the SDN controller is further configured to
determine whether a permission of communications to the one terminal of the plurality of terminals within the one SSID of the plurality of SSIDs under the one AP device is specified, in case the one AP device is in a privacy separator mode in which the communications to the one terminal of the plurality of terminals within the one SSID of the plurality of SSIDs under the one AP device are prohibited; and permit the communications to the determined one terminal if the permission of the communications to the one terminal is determined to be specified.

24. The security management system as claimed in claim 23, wherein the SDN controller is further configured to release the AP device from the privacy separator mode.

25. The security management system as claimed in claim 23, wherein the SDN controller is further configured to connect the one terminal to an SSID which is different from the one SSID of the SSIDs.

26. The security management system as claimed in claim 21, further comprising the plurality of terminals.

27. The security management system as claimed in claim 26, further comprising the plurality of networks.

28. The security management system as claimed in claim 27, further comprising the security monitoring device.

29. The security management system as claimed in claim 21, wherein the security monitoring device is a vulnerabilities monitoring device, the security issue list is a vulnerabilities list, and the list of the one or more security issues is a list of one or more vulnerabilities.

30. The security management system as claimed in claim 28, wherein the security monitoring device is a vulnerabilities monitoring device, the security issue list is a vulnerabilities list, and the list of the one or more security issues is a list of one or more vulnerabilities.
